(19) United States
(12) Patent Application Publication
(10) Pub. No.: US 2026/0104842 A1
(43) Pub. Date: Apr. 16, 2026

(54) DATA TRANSMISSION METHOD, APPARATUS AND STORAGE MEDIUM

(71) Applicant: Shanghai Awinic Technology Co., Ltd, Shanghai (CN)

(72) Inventor: Dong LIU, Shanghai (CN)

(21) Appl. No.: 19/420,315

(22) Filed: Dec. 15, 2025

Related U.S. Application Data
(63) Continuation of application No. PCT/CN2023/124873, filed on Oct. 17, 2023.

(30) Foreign Application Priority Data
Jun. 16, 2023 (CN) 202310722388.5

(51) Int. Cl. G06F 3/16; G06F 13/36

(52) U.S. Cl. CPC G06F 3/162; G06F 13/36

(57) ABSTRACT

The present invention relates to the field of data transmission technologies, and in particular, to a data transmission method, apparatus and storage medium. Specifically, the method comprises: the data encapsulation module obtaining a first audio data and a control instruction information; the data encapsulation module encapsulating the first audio data and the control instruction information according to a preset format to obtain encapsulated data, wherein the preset format is used to limit a relative position and a bit width of the first audio data and the control instruction information; and the data sending module transmitting the encapsulated data to the data interface module by using an audio bus. In this way, based on the foregoing data transmission method, audio data and a control instruction can be simultaneously transmitted by using an audio bus, and costs of a chip are reduced.

### CROSS-REFERENCE TO RELATED APPLICATIONS

This Application is a continuation of International Application No. PCT/CN2023/124873, filed on October 17, 2023, and entitled “DATA TRANSMISSION METHOD AND APPARATUS, AND ELECTRONIC DEVICE AND STORAGE MEDIUM”, which claims priority to Chinese Patent Application No. 202310722388.5, filed with the Chinese Patent Office on June 16, 2023 and entitled "DATA TRANSMISSION METHOD, APPARATUS, ELECTRONIC DEVICE, AND STORAGE MEDIA", each of which is incorporated herein by reference in its entirety.

### TECHNICAL FIELD

The present invention relates to the field of data transmission technologies, and in particular, to a data transmission method, apparatus and storage medium.

### BACKGROUND

A Inter‑IC Sound (I2S) bus, also referred to as an integrated circuit built-in audio bus, is a bus standard formulated by Philips for audio data transmission between digital audio devices. The bus is specifically used for data transmission between audio devices, and is widely used in various multimedia systems. In an existing interface data transmission solution of the I2S, audio data and a control instruction are separately transmitted by using different buses. For example, the I2S bus is only used to transmit audio data and a clock signal, and the control instruction is transmitted by another bus. The control instruction may include a gain control instruction, a voltage control instruction, a power control instruction, and the like.

It may be understood that an additional synchronization port or pin needs to be added to implement transmission of a control instruction by using another bus, thereby increasing costs of the chip.

### SUMMARY

The present disclosure provides a data transmission method, apparatus and storage medium. First audio data and control instruction information are encapsulated in a preset format, so that audio data and control instruction information are simultaneously transmitted by using an audio bus.

According to a first aspect, described is a data transmission method, applied to an electronic device, wherein the electronic device comprises a data encapsulation module, a data sending module, and a data interface module, and the method comprises: the data encapsulation module obtaining a first audio data and a control instruction information; the data encapsulation module encapsulating the first audio data and the control instruction information according to a preset format to obtain encapsulated data, wherein the preset format is used to limit a relative position and a bit width of the first audio data and the control instruction information; and the data sending module transmitting the encapsulated data to the data interface module by using an audio bus.

For example, the foregoing preset format may be an audio bus protocol, and the audio bus protocol is as follows: The audio bus may include a serial clock signal Sclk line, a periodic signal WS line, and a data line. Each frame of data transmitted by a data line in an audio bus includes N data slots. Different locations in each data slot may be corresponding to transmission of first audio data, first-type control instruction information, and second-type control instruction information. For example, a lowest 2+X+Log₂M bits on each data slot is a control instruction bit, where the lowest bit is used to transmit first-type control instruction information, and another X+Log₂M bits is used to transmit second-type control instruction information.

It may be understood that, when the encapsulation data is transmitted, the first audio data, the second-type control instruction information, and the first-type control instruction information are fixed to different locations in the data slot. Therefore, at a same moment, the audio bus may simultaneously transmit the audio data, the second-type control instruction information, and the first-type control instruction information without mutual interference. In addition, implementing the foregoing data transmission method may further reduce costs of the chip.

In a possible implementation of the first aspect, the electronic device further comprises a parsing module; and the method further includes: the data interface module decapsulating the encapsulated data to obtain the first audio data and the control instruction information; and the parsing module parseing the control instruction information based on a preset parsing protocol to acquire a control instruction and corresponding control information.

In a possible implementation of the first aspect, the control instruction information comprises a first-type control instruction information and a second-type control instruction information; the parsing protocol comprises a first sub-parsing protocol and a second sub-parsing protocol; the parsing module parsing the first-type control instruction information based on the first sub-parsing protocol to obtain a first control instruction and first control information, wherein the first control information comprises at least a first enable signal and a first register address; and the parsing module parsing the second-type control instruction information based on the second sub-parsing protocol, to obtain a second control instruction and second control information, wherein the second control information comprises at least a first flag bit.

In a possible implementation of the first aspect, the data encapsulation module encapsulating the first audio data and the control instruction information according to a preset format to obtain encapsulated data, wherein the preset format is used to limit the first audio data and a relative position and a bit width of the control instruction information, comprises: the data encapsulation module encapsulating the first audio data and the control instruction information according to an audio bus protocol, to obtain the encapsulated data, wherein the audio bus protocol is used to limit a relative position and a bit width of the first audio data and the control instruction information.

In a possible implementation of the first aspect, each frame of the encapsulation data comprises at least one data slot, and the data slot is divided into multiple areas; the bit width of the first audio data and the control instruction information in the encapsulated data are determined based on bit widths of multiple areas of the data slot.

In a possible implementation of the first aspect, the data sending module transmitting the encapsulated data to the data interface module by using an audio bus comprises: the data sending module sending different encapsulation data to the data interface module by using the audio bus based on different transmission signals.

In a possible implementation of the first aspect, the data sending module sending different encapsulation data to the data interface module by using the audio bus based on different transmission signals comprises: the data sending module sending a first encapsulation data to the data interface module by using the audio bus based on a first transmission signal, wherein the first encapsulation data comprises at least a first audio data; the data sending module sending a second encapsulation data to the data interface module by using the audio bus based on a second transmission signal, wherein the second encapsulation data comprises at least a first audio data and a first-type control instruction information; the data sending module sending a third encapsulated data to the data interface module by using the audio bus based on a third transmission signal, wherein the third encapsulated data comprises at least a first audio data and a second-type control instruction information; and the data sending module sending a fourth encapsulation data to the data interface module by using the audio bus based on a fourth transmission signal, wherein the fourth encapsulation data comprises at least a first audio data, a first-type control instruction information, and a second-type control instruction information.

In a possible implementation of the first aspect, the first transmission signal is used to indicate that a clock signal meets a first condition, and the first condition is used to indicate that a clock signal is on a falling edge; the second transmission signal is used to indicate that a clock signal meets a first condition and a first indication signal meets a second condition, wherein the first indication signal is used to control transmission of second-type control instruction information, and the second condition is used to indicate that the first indication signal is 1; the third transmission signal is used to indicate that a clock signal meets a first condition and a first periodic signal meets a third condition, wherein the third condition is that the first periodic signal is 1; and the fourth transmission signal is used to indicate that the clock signal meets the first condition, that the first indication signal meets the second condition, and that the first periodic signal meets the third condition.

In a possible implementation of the first aspect, the method further comprises: the parsing module writing the first control instruction into a first register corresponding to the first register address based on the first enable signal.

In a possible implementation of the first aspect, the method further comprises: when the parsing module parses and finds that the first flag bit is zero, it determines that the second-type control instruction is invalid; or when the parsing module parses and finds that the first flag bit is non-zero, it determines the control content corresponding to the second-type control instruction based on the value of the first flag bit and a preset correspondence for the second-type control instructions, wherein the correspondence is used to indicate a second-type control instruction corresponding to different value of the first flag bit.

According to a second aspect, described is an apparatus, applied to an electronic device, wherein the electronic device comprises a data encapsulation module, a data sending module, and a data interface module, the apparatus comprising: one or more processors and one or more memories, wherein the one or more memories store one or more programs configured to, when executed by the one or more processors, cause the apparatus to perform a method comprising: the data encapsulation module obtaining a first audio data and a control instruction information; the data encapsulation module encapsulating the first audio data and the control instruction information according to a preset format to obtain encapsulated data, wherein the preset format is used to limit a relative position and a bit width of the first audio data and the control instruction information; and the data sending module transmitting the encapsulated data to the data interface module by using an audio bus.

According to a third aspect, described is a non-transitory computer-readable storage medium, storing program instructions which, when executed by one or more processors of an apparatus, cause the apparatus to perform a method comprising: the data encapsulation module obtaining a first audio data and a control instruction information; the data encapsulation module encapsulating the first audio data and the control instruction information according to a preset format to obtain encapsulated data, wherein the preset format is used to limit a relative position and a bit width of the first audio data and the control instruction information; and the data sending module transmitting the encapsulated data to the data interface module by using an audio bus.

### BRIEF DESCRIPTION OF THE DRAWINGS

FIG. 1 is a schematic flowchart of a data transmission method according to an embodiment.

FIG. 2a is a schematic diagram of transmitting encapsulated data based on an audio bus protocol according to an embodiment.

FIG. 2b is another schematic diagram of transmitting encapsulated data based on an audio bus protocol according to an embodiment.

FIG. 3a is a schematic diagram of parsing a first sub-parsing protocol according to an embodiment.

FIG. 3b is a schematic diagram of parsing another first sub-parsing protocol according to an embodiment.

FIG. 4 is a schematic diagram of parsing a second sub-parsing protocol according to an embodiment.

FIG. 5 is a schematic module diagram of a data transmission apparatus according to an embodiment.

FIG. 6 is a schematic structural diagram of an electronic device according to an embodiment.

### DETAILED DESCRIPTION

To make the objectives, technical solutions, and advantages of the embodiments clearer, the following describes the technical solutions in the embodiments in detail with reference to the accompanying drawings and a specific implementation.

As described above, in a data transmission solution of an existing audio interface, audio data and a control instruction cannot be simultaneously transmitted by using an inter‑ic sound (I2S) bus.

To resolve the foregoing problem, some embodiments provides a data transmission method, which is applied to an electronic device. Specifically, in the method, the first audio data and the control instruction information are obtained by using the data encapsulation module in the foregoing electronic device, and the data encapsulation module encapsulates the first audio data and the control instruction information according to a preset format to obtain the encapsulated data. The preset format is used to limit a relative position and bit width of the first audio data and the control instruction information. The data sending module transmits the encapsulated data to the data interface module by using the audio bus.

In this way, based on the foregoing data transmission method, audio data and a control instruction can be simultaneously transmitted by using an I2S bus. During transmission of the encapsulated data, the first audio data, the second-type control instruction information, and the first-type control instruction information are fixed to different locations in the data slot. Therefore, at a same moment, audio data, second-type control instruction information, and first-type control instruction information may be simultaneously transmitted, and mutual interference is not performed, and costs of the chip are reduced.

In some embodiments, after decapsulating the encapsulation data, the audio interface module obtains the first audio data and the control instruction information. Further, the parsing module parses the control instruction information to obtain a corresponding control instruction and control information, and sends the corresponding control instruction to each control submodule according to the control information.

The foregoing preset format may be an audio bus protocol, and the audio bus protocol is as follows: The audio bus may include a serial clock signal Sclk line, a periodic signal WS line, and a data line. Each frame of data transmitted by a data line in an audio bus includes N data slots. Different locations in each data slot may be corresponding to transmission of first audio data, first-type control instruction information, and second-type control instruction information. For example, a lowest 2+X+Log₂M bit on each data slot is a control instruction bit, where the lowest 2 bits are used to transmit first-type control instruction information, and another X+Log₂M bit is used to transmit second-type control instruction information.

It may be understood that, when receiving the second-type control instruction information and the first-type control instruction information, the parsing module parses the control instruction information according to a corresponding parsing protocol to obtain a control instruction and corresponding control information. A parsing protocol for the first-type control instruction information and the second-type control instruction information is as follows:

The parsing module parses the first-type control instruction information according to the first sub-parsing protocol, and acquires the first control instruction and the first control information. The first control information includes a first enable signal and a first register address. In addition, when the parsing module obtains that the first enable signal is high, the parsing module writes the first control instruction into the first register corresponding to the first register address.

The parsing module parses the second-type control instruction information according to the second sub-parsing protocol, and acquires the second control instruction and the second control information, where the second control information includes at least a first flag bit. Determining control content of the corresponding second control instruction according to the data of the first flag bit.

The foregoing electronic device may be specifically an electronic device that has an audio play function, such as a wearable device, a mobile phone, a tablet computer, a notebook computer, an ultra-mobile personal computer (UMPC), a handheld computer, a netbook, a personal digital assistant (PDA), and a virtual reality device. This is not specifically limited in this embodiment.

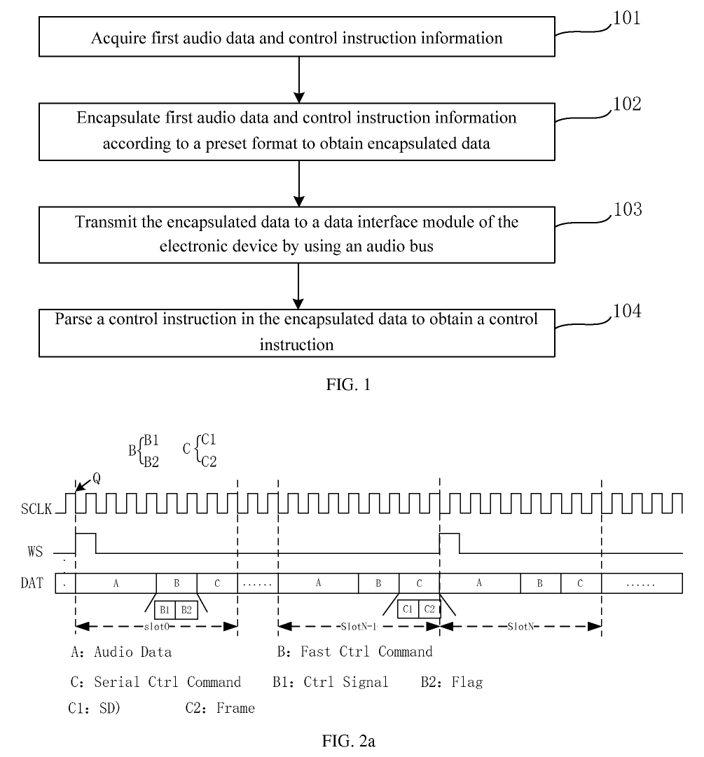

With reference to FIG. 1, the following describes in detail a specific implementation process of the data transmission method provided in this embodiment of this embodiment.

FIG. 1 is a schematic flowchart of a data transmission method according to an embodiment of this embodiment. It may be understood that each step in the method may be executed by a data transmission apparatus that implements the data transmission method in this embodiment. A specific structure of the data transmission apparatus or device is described in detail in the following, and details are not described herein again.

Specifically, the implementation procedure shown in FIG. 1 may include the following steps:

101. Acquire first audio data and control instruction information.

For example, the foregoing data transmission apparatus or device includes a data encapsulation module, configured to acquire first audio data and control instruction information.

In some embodiments, the foregoing first audio data and control instruction information may be obtained by means of processing by using a digital data processor (DSP) or an application processor (AP) in a data transmission apparatus or device. In an embodiment, a host exists in the foregoing data encapsulation module. The foregoing host may be a software module in a data transmission apparatus or device, and is configured to provide encapsulation data for the data interface module, or may be another electronic device connected to the data transmission apparatus or device. In some embodiments, the host may be a mobile phone, and an electronic device connected to the foregoing host may be, for example, a sound box, which is not limited herein.

102. Encapsulate first audio data and control instruction information according to a preset format to obtain encapsulated data.

For example, the data transmission apparatus or the device encapsulates the first audio data and the control instruction information according to the preset format to obtain the encapsulated data. The preset format is used to limit a relative position and bit width of the first audio data and the control instruction information.

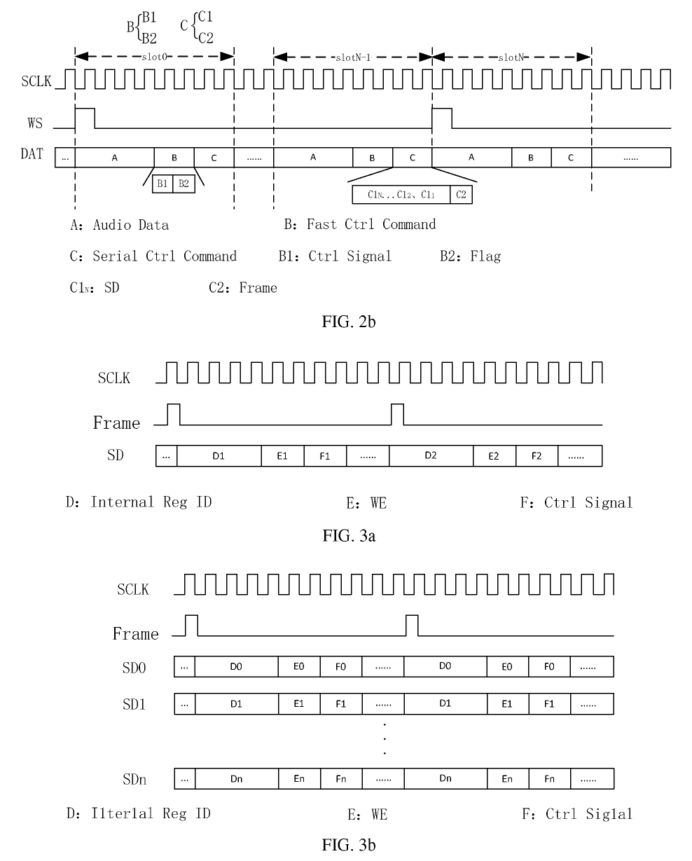

It may be understood that the foregoing preset format may be an audio bus protocol, and the audio bus protocol may be, for example, that each frame of data includes N data slots, and different locations on each data slot may correspondingly transmit first audio data, first-type control instruction information, and first-type control instruction information. For example, a lowest 2+X+Log₂M bit of each data slot is a control instruction bit, that is, the lowest 2 bits may be first-type control instruction information, and another X+Log₂M bit may be second-type control instruction information. In another embodiment, a sending sequence of the audio data and the control instruction in the data slot may be audio data, control instruction information of the second type, and control instruction information of the first type, or may be audio data, control instruction information of the first type, and control instruction information of the second type, which is not limited herein. The first-type control instruction information may be serially controlled, for example, C in FIG. 2a. The foregoing second-type control instruction information may quickly control instruction information, as shown in B in FIG. 2a. The foregoing locations may be a corresponding location sequence of A, B, and C shown in each data slot in FIG. 2a, or may be another corresponding location sequence such as A, C, and B.

103. Transmit the encapsulated data to a data interface module of the electronic device by using an audio bus.

For example, encapsulated data is transmitted to a data interface module of an electronic device by using an audio bus. As shown in FIG. 2a, when the serial clock signal Sclk is at a Q point, a data line in an audio bus starts to transmit encapsulated data. For example, when the serial clock signal Sclk is at a falling edge, the data line starts to transmit the encapsulated data. When it is detected that the signal Frame is high and the serial clock signal Sclk is on a falling edge, the first-type control instruction information whose bit width is 2bit is simultaneously started to be transmitted in the data line. When it is detected that the periodic signal WS is high and the serial clock signal Sclk is on a falling edge, the data line also transmits second-type control instruction information with a bit width of X+Log₂Mbit and the like.

It may be understood that the data sending module is configured to transmit different encapsulated data according to the serial clock signal Sclk, the first indication signal (that is, the signal Frame), and the first periodic signal WS.

For example, the data sending module sends the first encapsulation data to the data interface module by using the audio bus based on the first transmission signal, where the first encapsulation data includes at least the first audio data. The first transmission signal is used to indicate that the clock signal is at a falling edge.

The data sending module sends the second encapsulation data to the data interface module by using the audio bus based on the second transmission signal, where the second encapsulation data includes at least the first audio data and a first-type control instruction. The second transmission signal is used to indicate that the first indication signal is 1 or is high (for example, a signal Frame is high) and the clock signal is at a falling edge.

The data sending module sends the third encapsulated data to the data interface module by using the audio bus based on the third transmission signal, where the third encapsulated data includes at least the first audio data and a second-type control instruction. The third transmission signal is used to indicate that the first period signal is 1 or is high and the clock signal is on a falling edge.

The data sending module sends the third encapsulated data to the data interface module by using the audio bus based on the fourth transmission signal, where the fourth encapsulated data includes at least first audio data, a first-type control instruction, and a second-type control instruction. The fourth transmission signal is used to indicate that the first indication signal is 1 or high (for example, a signal Frame is high), the first period signal is 1 or high, and the clock signal is at a falling edge.

It may be understood that, during encapsulation data transmission, the first audio data, the second-type control instruction information, and the first-type control instruction information are fixed at different locations in a data slot in a data cable. Therefore, at a same moment, audio data, control instruction information of a second type, and control instruction information of a first type may be simultaneously transmitted, and mutual interference is not performed.

104. Parse a control instruction in the encapsulated data to obtain a control instruction.

For example, the foregoing data transmission apparatus further includes a parsing module, configured to parse control instruction information according to a corresponding parsing protocol.

In some embodiments, the foregoing first sub-parsing protocol used to parse the first type of control instruction information may be: When the first indication signal meets a second condition, that is, when the signal Frame is 1 or high and the serial clock signal Sclk is on a falling edge, the first register address (that is, Internal Reg ID) whose bit width is nbit, the first enable signal (that is, WE) whose bit width is mbit, and the first control instruction (that is, Ctrl Signal) whose bit width is pbit are sequentially sent according to the audio bus protocol. The first-type control instruction information occupies only 2bit bits in each data slot, and the first indication signal (that is, a signal Frame) needs to occupy 1bit bits in a transmission process. The other bit is used as a data bit (that is, an SD) to transmit the first register address, the first enable signal, and the first control instruction. Therefore, when the transmission bit width is the first register address of the nbit bits, n WS periods are required to complete transmission of the first register address. Further, the first enable signal whose bit width is mbit is transmitted starting from the (n + 1) th cycle, and the first enable signal can be transmitted only when m WS cycles are required. Further, starting to transmit the first control instruction whose bit width is pbit in the (pbit + 1) th cycle, p WS cycles are required for completing transmission of the first control instruction. When all the foregoing data is transmitted, it indicates that the first-type control instruction information is transmitted one time. For example, as shown in FIG. 3a, when the signal Frame is high and the serial clock signal is at a falling edge, the data bit SD transmits a first register address whose bit width is 7bit in the first seven periods, that is, D in FIG. 3a. A first enable signal whose transmission bit width of the eighth cycle data bit SD is 1bit, that is, E in FIG. 3a; A first control instruction whose transmission bit width of the last eight periodic data bits SD is 8bit, that is, F in FIG. 3a.

When the parsing module detects that the first enable signal is high, the parsing module may write the received first control instruction into the first register corresponding to the first register address. In another embodiment, a bit width and a sending sequence of the first register address, the first enable signal, and the first control instruction may be properly set according to an actual requirement, which is not limited herein.

It may be understood that, in another embodiment, a bit number of a data bit (that is, an SD) of first-type control instruction information may be increased by N bits. For example, as shown in FIG. 3b, a bit number of a data bit increases, and transmission efficiency of a corresponding control instruction increases. Therefore, a quantity of data bits SD may be properly set according to an actual situation, which is not limited herein.

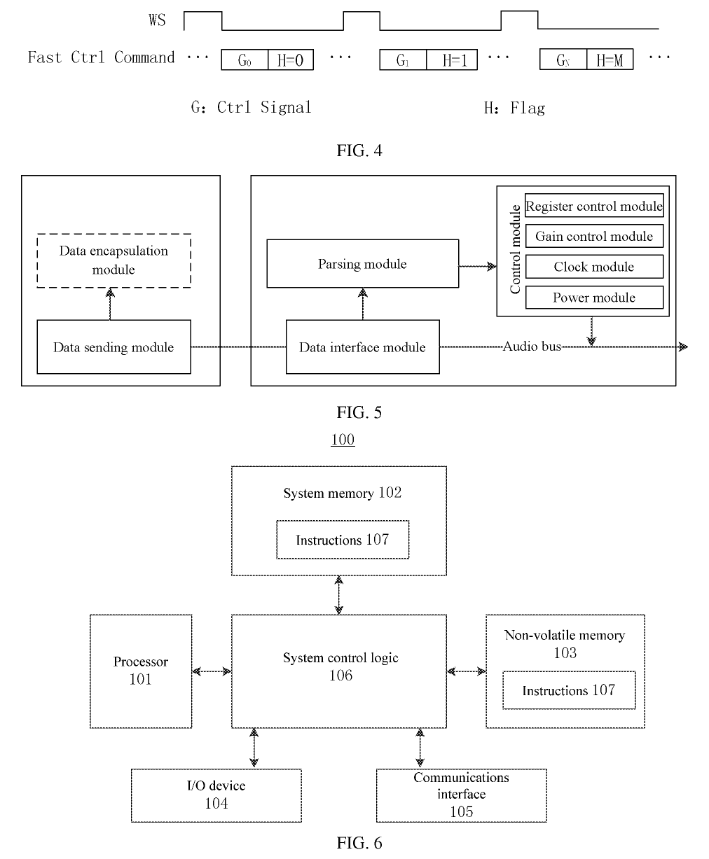

It may be understood that the second sub-parsing protocol used to parse the second-type control instruction information may be: When the first periodic signal WS is 1 or higher and the serial clock signal Sclk meets the first condition, the data line in the audio bus sends the second control instruction (that is, Ctrl Signal) and the first flag bit (that is, Flag) according to a predetermined sequence and bit width. A quantity of bits of the second control instruction is X bit, and a quantity of bits of a corresponding first flag bit is Log₂M bit, that is, a quantity of built-in control instructions is M. It may be understood that a second control instruction may be sent in one WS cycle. When the first flag bit = 0, it indicates that the second-type control instruction information is currently in an idle state. When the first flag bit is a non-zero value, parsing may be performed according to a preset instruction set. For example, when the first flag bit = 1, the transmission control instruction is corresponding to a clock frequency setting. When the first flag bit = 2, the transmitted control instruction pair should be voltage amplitude setting or the like. For example, as shown in FIG. 4, when a WS is 1 or high and a serial clock signal Sclk meets a first condition, a data line starts to transmit a control instruction, that is, G and a flag bit in FIG. 4, that is, H in FIG. 4. The instruction set may be adjusted and set according to an actual situation, which is not limited herein.

It may be understood that the second-type control instruction information is faster than the first-type control instruction information. Therefore, the control data for transmitting the second-type control instruction information and the first-type control instruction information may be adjusted according to an actual situation, which is not limited herein. In addition, a second-type control instruction information transmission manner is faster than a first-type control instruction information transmission manner. Therefore, the transmission control instruction may be selected in a proper manner according to an actual situation, which is not limited herein. In other embodiments, only one of the fast transmission manner or the serial transmission manner may be selected to transmit the control instruction, for example, the control instruction is transmitted only in the fast transmission manner.

In this embodiment, the foregoing data transmission method may further include: Performing real-time adjustment on the audio data by using the parsed control instruction.

It may be understood that the foregoing step 101 to step 104 may be implemented by the following modules in FIG. 5. FIG. 5 shows a schematic module diagram of a data transmission apparatus according to an embodiment.

As shown in FIG. 5, the foregoing data transmission apparatus includes a data encapsulation module, a data sending module, a data interface module, a parsing module, and a control module. The control module includes multiple control word modules, such as a gain control module, a clock module, a power module, and a register control module.

It may be understood that the foregoing data encapsulation module and the data sending module are located in an upper computer. The upper computer may be a software module in the electronic device, and is configured to provide the data interface module with encapsulation data, or may be another electronic device connected to the electronic device. In some embodiments, the upper computer may be a mobile phone, and an electronic device connected to the upper computer may be, for example, a sound box, which is not limited herein.

The data encapsulation module is configured to encapsulate the first audio data and the control instruction information according to the audio bus protocol. The audio bus protocol is described in detail in the foregoing step 102, and details are not described herein again.

The data sending module is configured to transmit the corresponding encapsulation data to the data interface module by using the audio bus according to the transmission signal.

The data interface module is connected to the host through the audio bus to implement communication with the host and receive the encapsulated data transmitted by the host. The audio bus may be an I2S bus or a TDM bus. For example, the audio interface module receives, by using the I2S bus, the encapsulation data transmitted by the host, and is further configured to decapsulate the received encapsulation data, so as to obtain the first audio transmission data and the control instruction information.

The parsing module is configured to parse control instruction information according to a corresponding parsing protocol.

The control module includes multiple control submodules, configured to adjust a related parameter of the audio data according to a corresponding control instruction.

An embodiment further provides an electronic device 100, configured to execute the foregoing data transmission method shown in FIG. 1. FIG. 6 is a schematic structural diagram of an electronic device 100 according to an embodiment.

As shown in FIG. 6, the electronic device 100 includes one or more processors 101, a system memory 102, a non-volatile memory (NVM) 103, an input/output (I/O) device 104, a communications interface 105, and a system control logic 106 configured to couple the processor 101, the system memory 102, the non-volatile memory 103, the communications interface 105, and the input/output (I/O) device 104. Where:

The processor 101 may include one or more processing units, for example, a data processing unit or a processing circuit that may include a central processing unit (CPU), an graphics processing unit (GPU), a digital signal processor (DSP), a micro-programmed control unit (MCU), an artificial intelligence (AI), a field programmable gate array (FPGA), a Neural-network Processing Unit (NPU), or the like.

The system memory 102 is a volatile memory, such as a random-access memory (RAM), and a double data rate synchronous dynamic random access memory (DDR SDRAM). The system memory is used to temporarily store data and/or instructions. For example, in some embodiments, the system memory 102 may be configured to store parsed control instructions.

The non-volatile memory 103 may include one or more tangible, non-temporary, computer-readable media for storing data and/or instructions. In some embodiments, the non-volatile memory 103 may include any suitable non-volatile memory such as a flash memory and/or any suitable non-volatile storage device such as a hard disk drive (HDD), an compact disc (CD), a digital versatile disc (DVD), or a solid-state drive (SSD). In some embodiments, the non-volatile memory 103 may also be a removable storage medium, such as a secure digital (SD) memory card.

In particular, the system memory 102 and the non-volatile memory 103 may respectively include a temporary copy and a permanent copy of the instructions 107. The instructions 107 may include: Enabling the electronic device 100 to implement the data transmission method provided in the embodiments described when at least one of the processors 101 is executed.

The communications interface 105 may include a transceiver configured to provide a wired or wireless communications interface for the electronic device 100, and further communicate with any other suitable device by using one or more networks. In some embodiments, the communications interface 105 may be integrated into other components of the electronic device 100, such as the communications interface 105 may be integrated into the processor 101. In some embodiments, electronic device 100 may communicate with other devices via communication interface 105.

The input/output (I/O) device 104 may include an input device such as a keyboard, a mouse, an output device such as a display, and the user may interact with the electronic device 100 by using the input/output (I/O) device 104.

The system control logic 106 may include any suitable interface controller that provides any suitable interface for another module of the electronic device 100. For example, in some embodiments, the system control logic 106 may include one or more memory controllers to provide interfaces connected to the system memory 102 and the non-volatile memory 103.

In some embodiments, at least one of the processors 101 may be encapsulated with logic of one or more controllers for system control logic 106 to form a system in package (SiP). In other embodiments, at least one of the processors 101 may also be integrated on the same chip as logic of one or more controllers configured for the system control logic 106 to form a system-on-chip (SOC).

It may be understood that the structure of the electronic device 100 shown in FIG. 6 is merely an example. In other embodiments, the electronic device 100 may include more or fewer components than those shown in the figure, or combine some components, or split some components, or have different component arrangements. The components shown may be implemented in hardware, software, or a combination of software and hardware, which is not limited herein.

An embodiment further provides a chip, and the chip includes, for example, a data transmission apparatus.

An embodiment further provides a computer program product, which is used to implement the data transmission method provided in the foregoing embodiments.

Embodiments of the mechanisms disclosed may be implemented in hardware, software, firmware, or a combination of these implementation methods. The embodiments described may be implemented as computer module or module code executed on a programmable system. The programmable system includes at least one processor, a storage system (including a volatile and non-volatile memory and/or a storage element), at least one input device, and at least one output device.

The module code may be applied to an input instruction, so as to execute functions described and generate output information. The output information may be applied to one or more output devices in a known manner. For the purposes of some embodiments, a processing system includes any system having a processor such as a digital signal processor (DSP), a microcontroller, a application specific integrated circuit (ASIC), or a microprocessor.

Module code may be implemented in advanced modular or object-oriented programming languages to communicate with the processing system. Module code may also be implemented in assembly language or machine language when required. In fact, the mechanisms described are not limited to the scope of any specific programming language. In either case, the language may be a compilation language or an interpretation language.

In some cases, the disclosed embodiments may be implemented in hardware, firmware, software, or any combination thereof. The disclosed embodiments may also be implemented as instructions carried or stored on one or more temporary or non-temporary machine readable (e.g., computer readable) storage media that may be read and executed by one or more processors. For example, instructions may be distributed over a network or through another computer readable medium. Thus, the machine readable medium may include any mechanism for storing or transmitting information in a form readable by a machine (e.g., a computer), including but not limited to a floppy disk, an optical disc, an optical disc, a CD read-only memory (CD-ROMs), a magneto-optical disc, a read-only memory (ROM), a random access memory (RAM), an erasable programmable read-only memory (EPROM), an electrically erasable programmable read-only memory (EEPROM), a magnetic card or an optical card, a flash memory, or a machine readable memory that is configured to transmit information (e.g., a carrier, an infrared signal digital signal) by using a signal propagating in an electrical, optical, audio, or other form to the Internet. Thus, the machine readable medium includes any type of machine readable medium suitable for storing or transmitting electronic instructions or information in a form readable by a machine (e.g., a computer).

In the accompanying drawings, some structural or method features may be shown in a particular arrangement and/or sequence. However, it should be understood that such specific arrangements and/or sorting may not be required. Rather, in some embodiments, these features may be arranged in a different manner and/or in a different order from that shown in the illustrative drawings. In addition, including structural or method features in a particular graph does not imply that such features are required in all embodiments, and in some embodiments, these features may not be included or may be combined with other features. The reference to "one embodiment" or "embodiment" in the specification means that a specific feature, structure, or feature described with reference to the embodiments is included in at least one example implementation solution or technology disclosed in the embodiments. The phrase "in one embodiment" in each place in the specification does not necessarily refer to all the same embodiments.

The disclosure of the embodiments further relates to an operation apparatus used to execute the text. The apparatus may be constructed for a specific purpose or may include a general-purpose computer that is selectively activated or reconfigured by a computer program stored in the computer. Such a computer program may be stored in a computer readable medium, such as but is not limited to any type of disk, including a floppy disk, an optical disc, a CD-ROM, a magneto-optical disc, a read-only memory (ROM), a random access memory (RAM), an EPROM, an EEPROM, a magnetic or optical card, an application specific integrated circuit (ASIC), or any type of medium suitable for storing an electronic instruction, and each may be coupled to a computer system bus. In addition, the computer mentioned in the specification may include a single processor or may be an architecture involved in multiple processors that use the added computing capability.

It should be further stated that, in the embodiments described, steps in a method and a procedure are numbered for ease of reference, and are not limited to a sequence. If there is a sequence between steps, a text description prevails.

In addition, the language used in this specification has been selected primarily for readable and instructive purposes and may not be selected for the subject matter disclosed in the description or limitation. Therefore, the embodiments described are disclosed to illustrate and not limit the scope of the concepts discussed herein.

1. A data transmission method, applied to an electronic device, wherein the electronic device comprises a data encapsulation module, a data sending module, and a data interface module, and the method comprises:
the data encapsulation module obtaining a first audio data and control instruction information;
the data encapsulation module encapsulating the first audio data and the control instruction information according to a preset format to obtain encapsulated data, wherein the preset format is used to limit the relative position and bit width of the first audio data and the control instruction information; and
the data sending module transmitting the encapsulated data to the data interface module by using an audio bus.

2. The method of claim 1, wherein the electronic device further comprises a parsing module; and the method further includes:
the data interface module decapsulating the encapsulated data to obtain the first audio data and the control instruction information; and
the parsing module parseing the control instruction information based on a preset parsing protocol to acquire the control instruction and corresponding control information.

3. The method of claim 2, wherein
the control instruction information comprises a first-type control instruction information and a second-type control instruction information; the parsing protocol comprises a first sub-parsing protocol and a second sub-parsing protocol;
the parsing module parsing the first-type control instruction information based on the first sub-parsing protocol to obtain a first control instruction and first control information, wherein the first control information comprises at least a first enable signal and a first register address; and
the parsing module parsing the second-type control instruction information based on the second sub-parsing protocol, to obtain a second control instruction and second control information, wherein the second control information comprises at least a first flag bit.

4. The method of claim 1, wherein the data encapsulation module encapsulating the first audio data and the control instruction information according to a preset format to obtain encapsulated data, wherein the preset format is used to limit the first audio data and a relative position and a bit width of the control instruction information, comprises:
the data encapsulation module encapsulating the first audio data and the control instruction information according to an audio bus protocol, to obtain the encapsulated data, wherein the audio bus protocol is used to limit a relative position and a bit width of the first audio data and the control instruction information.

5. The method of claim 4, wherein each frame of the encapsulation data comprises at least one data slot, and the data slot is divided into multiple areas;
the bit width of the first audio data and the control instruction information in the encapsulated data are determined based on bit widths of multiple areas of the data slot.

6. The method of claim 1, wherein the data sending module transmitting the encapsulated data to the data interface module by using an audio bus comprises:
the data sending module sending different encapsulation data to the data interface module by using the audio bus based on different transmission signals.

7. The method of claim 6, wherein the data sending module sending different encapsulation data to the data interface module by using the audio bus based on different transmission signals comprises:
the data sending module sending a first encapsulation data to the data interface module by using the audio bus based on a first transmission signal, wherein the first encapsulation data comprises at least a first audio data;
the data sending module sending a second encapsulation data to the data interface module by using the audio bus based on a second transmission signal, wherein the second encapsulation data comprises at least a first audio data and a first-type control instruction information;
the data sending module sending a third encapsulated data to the data interface module by using the audio bus based on a third transmission signal, wherein the third encapsulated data comprises at least a first audio data and a second-type control instruction information; and
the data sending module sending a fourth encapsulation data to the data interface module by using the audio bus based on a fourth transmission signal, wherein the fourth encapsulation data comprises at least a first audio data, a first-type control instruction information, and a second-type control instruction information.

8. The method of claim 7, wherein
the first transmission signal is used to indicate that a clock signal meets a first condition, and the first condition is used to indicate that a clock signal is on a falling edge;
the second transmission signal is used to indicate that a clock signal meets a first condition and a first indication signal meets a second condition, wherein the first indication signal is used to control transmission of second-type control instruction information, and the second condition is used to indicate that the first indication signal is 1;
the third transmission signal is used to indicate that a clock signal meets a first condition and a first periodic signal meets a third condition, wherein the third condition is that the first periodic signal is 1; and
the fourth transmission signal is used to indicate that the clock signal meets the first condition, that the first indication signal meets the second condition, and that the first periodic signal meets the third condition.

9. The method of claim 3, wherein the method further comprises:
the parsing module writing the first control instruction into a first register corresponding to the first register address based on the first enable signal.

10. The method of claim 3, wherein the method further comprises:
when the parsing module parses and finds that the first flag bit is zero, it determines that the second-type control instruction is invalid; or
when the parsing module parses and finds that the first flag bit is non-zero, it determines the control content corresponding to the second-type control instruction based on the value of the first flag bit and a preset correspondence for the second-type control instructions, wherein the correspondence is used to indicate a second-type control instruction corresponding to different value of the first flag bit.

11. An apparatus, applied to an electronic device, wherein the electronic device comprises a data encapsulation module, a data sending module, and a data interface module, the apparatus comprising:
one or more processors and one or more memories, wherein the one or more memories store one or more programs configured to, when executed by the one or more processors, cause the apparatus to perform a method of comprising:
the data encapsulation module obtaining a first audio data and a control instruction information;
the data encapsulation module encapsulating the first audio data and the control instruction information according to a preset format to obtain encapsulated data, wherein the preset format is used to limit a relative position and a bit width of the first audio data and the control instruction information; and
the data sending module transmitting the encapsulated data to the data interface module by using an audio bus.

12. A non-transitory computer-readable storage medium, storing program instructions which, when executed by one or more processors of an apparatus, cause the apparatus to perform a method comprising:
the data encapsulation module obtaining a first audio data and a control instruction information;
the data encapsulation module encapsulating the first audio data and the control instruction information according to a preset format to obtain encapsulated data, wherein the preset format is used to limit a relative position and a bit width of the first audio data and the control instruction information; and
the data sending module transmitting the encapsulated data to the data interface module by using an audio bus.
